(19) United States
(12) Patent Application Publication
(10) Pub. No.: US 2013/0065061 A1
(43) Pub. Date: Mar. 14, 2013

(54) BUILDING BOARD AND BUILDING BOARD PRODUCTION METHOD

(71) Applicants: Takahiro YAMAGUCHI, Ama-gun (JP); Akira MOCHIZUKI, Nagoya-shi (JP); Hiroyuki YAMAUCHI, Nagoya-shi (JP)

(72) Inventors: Takahiro YAMAGUCHI, Ama-gun (JP); Akira MOCHIZUKI, Nagoya-shi (JP); Hiroyuki YAMAUCHI, Nagoya-shi (JP)

(73) Assignee: NICHIHA CORPORATION, Nagoya-shi (JP)

(21) Appl. No.: 13/230,569

(22) Filed: Sep. 12, 2011

(51) Int. Cl. B32B 27/00; B05D 3/06; B32B 9/00

(52) U.S. Cl. 428/421; 428/447; 428/688; 427/511

(57) ABSTRACT

In a building board, a base coating film, an inkjet coating film and a clear coating film are sequentially formed on a surface of an inorganic board; the inkjet coating film is a cured product of a UV-curable ink; and the clear coating film contains 0.1 to 10.0 wt % of a light stabilizer and/or ultraviolet absorbent. A method of producing a building board includes the steps of: implementing base coating onto a surface of an inorganic board; performing inkjet coating by coating a UV-curable ink onto the surface of the base-coated inorganic board and curing the UV-curable ink through irradiation of UV rays; and performing clear coating by applying a clear coating material containing 0.1 to 10.0 wt %, on solids basis, of a light stabilizer and/or ultraviolet absorbent, onto the surface of the inkjet-coated inorganic board.

### BACKGROUND OF THE INVENTION

1. Field of the Invention

The present invention relates to a building board suitably used as a wall material, and to a method of producing the building board.

2. Description of the Related Art

Conventional inorganic boards have, as main components, a water-settable inorganic powder such as a cement and a wooden reinforcing material such as wood pulp fibers. Such inorganic boards have excellent properties, for instance flexural strength, and hence are used, as coated boards, in, for example, inner wall materials and outer siding materials in houses. For instance, Japanese Patent Application Publication No. 2007-162245 discloses a building board in which, via an undercoat layer, that are disposed an intermediate coat layer containing an ink-adsorbing component and an inkjet coating layer, in this order.

In the building board disclosed in Japanese Patent Application Publication No. 2007-162245, however, the ink in the inkjet coating layer becomes adhered through adsorption onto the intermediate coat layer. This is problematic, in that, as a result, the hue of the inkjet coating layer varies depending on the drying state of the intermediate coat layer.

Ever more challenging quality requirements in recent years have resulted in a demand for coatings that have high weathering performance with little color fading even after 20 years.

### SUMMARY OF THE INVENTION

Therefore, it is an object of the present invention to provide a building board that has an inkjet coating film that is unaffected by the drying state of the base coating film, such that the building board exhibits high weathering performance, and to provide a method of producing the building board.

The present invention provides a building board. In the building board of the present invention, a base coating film, an inkjet coating film and a clear coating film are formed, in this order, on the surface of an inorganic board. The inorganic board is, for instance, a ceramic siding board such as a wood fiber reinforced cement board, a fiber reinforced cement board, a fiber reinforced cement-calcium silicate board or a slag gypsum board; or a metallic siding board, an ALC board or the like. The base coating film comprises, for instance, an acrylic resin, a silicone resin, a fluororesin, an acrylic silicone resin, a polyurethane resin, an epoxy resin or the like. The inkjet coating film comprises a cured product of a UV-curable ink. The clear coating film comprises an acrylic silicone resin, a fluororesin, an acrylic resin, a silicone resin, a polyurethane resin, an epoxy resin or an inorganic material. In terms of weathering performance, however, the clear coating film comprises at least any from among an acrylic silicone resin, a fluororesin and an inorganic material. The clear coating film contains 0.1 to 10.0 wt % of a light stabilizer and/or an ultraviolet absorbent.

In the present invention, an inkjet coating film, as a cured product of a UV-curable ink, is formed on a base coating film. An inkjet coating film layer can be obtained as a result that is unaffected by the drying state of the base coating film. The clear coating film comprises 0.1 to 10.0 wt % of a light stabilizer and/or an ultraviolet absorbent. As a result, the clear coating film has high weathering performance and little color fading even after 20 years.

The UV-curable ink may be a dye-based ink, or a pigment-based ink, or may comprise both a dye-based ink and a pigment-based ink.

Examples of light stabilizers include, for instance, those based on a hindered amine. Ultraviolet absorbents include organic and inorganic ones. Examples of organic ultraviolet absorbents include, for instance, benzophenone-based, benzotriazole-based, salicylate-based, cyanoacrylate-based and triazine-based ones. Examples of inorganic ultraviolet absorbents include, for instance, titanium oxide, chromium oxide, zinc oxide, black iron oxide, zirconium oxide, alumina, talc and kaolin.

The present invention provides also a method of producing a building board. The method of producing a building board of the present invention comprises the steps of: implementing base coating onto a surface of an inorganic board; performing inkjet coating on the surface of the base-coated inorganic board; and performing clear coating on the surface of the inkjet-coated inorganic board; wherein inkjet coating is performed by applying a UV-curable ink and curing the UV-curable ink through irradiation of UV rays; and clear coating is performed by applying a clear coating material containing 0.1 to 10.0 wt %, on solids basis, of a light stabilizer and/or ultraviolet absorbent. As a result there can be produced a building board having a inkjet coating film layer that is unaffected by the drying state of the base coating film, such that the building board exhibits high weathering performance.

In implementing base coating there can be used a coating material comprising, for instance, an acrylic resin, a silicone resin, a fluororesin, an acrylic silicone resin, a polyurethane resin, an epoxy resin or the like. The UV-curable ink may be a dye-based ink or a pigment-based ink, or may comprise both a dye-based ink and a pigment-based ink. In clear coating there can be used a coating material comprising, for instance, an acrylic silicone resin, a fluororesin, an acrylic resin, a silicone resin, a polyurethane resin, an epoxy resin or an inorganic material. In terms of weathering performance, however, there is preferably used a coating material that comprises at least any from among an acrylic silicone resin, a fluororesin and an inorganic material. A hindered amine-based light stabilizer or the like can be used as the light stabilizer. An organic or inorganic ultraviolet absorbent can be used as the ultraviolet absorbent. The above-described substances can be used as the organic or inorganic ultraviolet absorbent.

In the present invention, preferably, the base coating film is formed through coating of 30 to 150 g/m² of coating material. An amount smaller than 30 g/m² may result in, for instance, poor waterproofing performance and poor adhesion to an inorganic board. If the amount is greater than 150 g/m², cracks may appear in the coating film during drying, and workability may become significantly impaired.

Preferably, the clear coating film is formed by coating 50 to 150 g/m² of a clear coating material. An amount smaller than 50 g/m² may result in poor waterproofing performance, and high weathering performance may fail to be achieved. If the amount is greater than 150 g/m², cracks may appear in the coating film during drying, and workability may become significantly impaired.

The present invention succeeds in providing a building board, boasting high weathering performance, that has an inkjet coating film that is unaffected by the drying state of the base coating film, and a coating method of the building board.

### DESCRIPTION OF THE PREFERRED EMBODIMENTS

Examples of the present invention are explained next.

There were coated 50 g/m² of an aqueous coating material having an acrylic resin as a main component onto the surface of a 14-mm thick smooth-surface inorganic board comprising a cement, silica sand and pulp, followed by drying for about 3 minutes in a dryer at about 120° C. On the surface there were coated next 90 g/m² of an aqueous coating material containing a pigment and having an acrylic silicone resin as a main component, followed by drying for about 5 minutes in a dryer at about 120° C. A marbled pattern was imparted to the surface by using four-color UV-curable inks, namely cyan, magenta, yellow and black. The coating apparatus of the UV-curable ink was provided with an UV irradiating unit at the back of ink-jetting ports. After jetting, the ink was immediately cured through irradiation of UV rays. Dye-based inks were used for all the UV-curable inks of four colors. Onto the surface there were coated 110 g/m² of a clear coating material containing 0.5 wt %, on solids basis, of a hindered amine-based light stabilizer and having an acrylic silicone resin as a main component, followed by drying for about 15 minutes in a dryer at about 100° C., to yield a building board of Example 1.

Coating was performed in the same way as in Example 1, but herein, 90 g/m² of an aqueous coating material containing a pigment and having an acrylic silicone resin as a main component were applied, followed by drying for about 5 minutes in a dryer at about 120° C., and the board was left to stand at normal temperature for one day, after which UV-curable inks of four colors were applied, to yield a building board of Example 2.

Coating was performed in the same way as in Example 1, but herein the UV-curable inks of four colors were changed to pigment-based inks, to yield a building board of Example 3.

Coating was performed in the same way as in Example 1, but the black ink alone, from among the UV-curable inks of four colors, was changed to a pigment-based ink, to yield a building board of Example 4.

Coating was performed in the same way as in Example 1, but herein the clear coating material containing 0.5 wt %, on solids basis, of a hindered amine-based light stabilizer and having an acrylic silicone resin as a main component was changed to a clear coating material containing 1.5 wt %, on solids basis, of a benzophenone-based ultraviolet absorbent and having an acrylic silicone resin as a main component, to yield a building board of Example 5.

Coating was performed in the same way as in Example 1, but herein the clear coating material containing 0.5 wt %, on solids basis, of a hindered amine-based light stabilizer and having an acrylic silicone resin as a main component was changed to a clear coating material containing 1.0 wt %, on solids basis, of zinc oxide and having an acrylic silicone resin as a main component, to yield a building board of Example 6.

Coating was performed in the same way as in Example 1, but herein the clear coating material containing 0.5 wt %, on solids basis, of a hindered amine-based light stabilizer and having an acrylic silicone resin as a main component was changed to a clear coating material having an acrylic silicone resin as a main component and containing 0.5 wt %, on solids basis, of a hindered amine-based light stabilizer, and 0.8 wt %, on solids basis, of a benzophenone-based ultraviolet absorbent, to yield a building board of Example 7.

Coating was performed in the same way as in Example 1, but herein the clear coating material containing 0.5 wt %, on solids basis, of a hindered amine-based light stabilizer and having an acrylic silicone resin as a main component was changed to a clear coating material having a fluororesin as a main component and containing 0.5 wt %, on solids basis, of a hindered amine-based light stabilizer, and 0.8 wt %, on solids basis, of a benzophenone-based ultraviolet absorbent, to yield a building board of Example 8.

Coating was performed in the same way as in Example 1 but changing herein the UV-curable inks of four colors to non-UV-curable conventional inks, to yield a building board of Comparative example 1.

Coating was performed in the same way as in Example 1, but herein there was coated no clear coating material containing 0.5 wt %, on solids basis, of a hindered amine-based light stabilizer and having an acrylic silicone resin as a main component, to yield a building board of Comparative example 2.

Coating was performed in the same way as in Example 1, but herein the clear coating material containing 0.5 wt %, on solids basis, of a hindered amine-based light stabilizer and having an acrylic silicone resin as a main component was changed to a clear coating material containing 20.0 wt %, on solids basis, of a hindered amine-based light stabilizer and having an acrylic silicone resin as a main component, to yield a building board of Comparative example 3.

The coating condition of the obtained Examples 1 to 8 and Comparative examples 1 to 3 was observed, and weathering performance, coating film adhesion performance and freeze-thaw resistance performance were measured. In the weathering performance test, the specimens were subjected to 30 test cycles wherein each cycle involved UV irradiation for 16 hours using a metal halide lamp as a light source (temperature 65° C., humidity 70%), two hours of no UV irradiation (temperature 65° C., humidity 70%), 10 seconds of shower spray, 6 hours of dew condensation (temperature 30° C., humidity 98%) and 10 seconds of shower spray. Each specimen was evaluated by comparing the appearance and color differences of the coating film before and after the test. As regards coating film adhesion performance, the specimens were caused to absorb water through immersion in water for 24 hours, followed by humidity conditioning at 50° C. and relative humidity RH70% for 2 hours, after which a peeling test was performed using an adhesive tape. The coating film adhesion performance was evaluated on the basis of the adhesiveness of the coating film. To evaluate freeze-thaw resistance performance, the specimens were subjected to 300 cycles according to ASTM B, and were then checked for anomalies.

In the building boards of Examples 1 to 8, the marbled pattern was imparted sharply by the inkjet coating film, and no anomalies such as color fading, coating film peeling and the like were observed in the weathering performance test, the coating film adhesion performance test or the freeze-thaw resistance performance test. No hue differences were observed in the marbled patterns of Examples 1 and 2.

By contrast, the building board of Comparative example 1 exhibited a blurred marbled pattern by the inkjet coating film, and performed poorly, i.e. exhibited coating film peeling, stark color fading and the like in the weathering performance test, the coating film adhesion performance test and the freeze-thaw resistance performance test.

The building board of Comparative example 2 was imparted with a sharp marbled pattern by the inkjet coating film, but performed poorly, i.e. exhibited coating film peeling, stark color fading and the like in the weathering performance test, the coating film adhesion performance test and the freeze-thaw resistance performance test.

The building board of Comparative example 3 was imparted with a sharp marbled pattern by the inkjet coating film, and no color fading was observed in the weathering performance test. However, the performance of the building board was poor, for instance due to peeling of part of the coating film, in the coating film adhesion performance test and the freeze-thaw resistance performance test.

Embodiments of the present invention have been explained above, but the present invention is not limited thereto, and can be embodied in various manners wiring board departing from the scope of the invention as defined in the appended claims.

As explained above, the present invention succeeds in providing a building board, boasting high weathering performance, that has an inkjet coating film that is unaffected by the drying state of the base coating film, and succeeds in providing a coating method of the building board.

What is claimed is:

1. A building board, wherein
abase coating film, an inkjet coating film and a clear coating film are sequentially formed on a surface of an inorganic board;
the inkjet coating film is a cured product of a UV-curable ink; and
the clear coating film contains 0.1 to 10.0 wt % of a light stabilizer and/or ultraviolet absorbent.

2. The building board according to claim 1, wherein the UV-curable ink is a dye-based ink.

3. The building board according to claim 1, wherein the UV-curable ink is a pigment-based ink.

4. The building board according to claim 1, wherein the UV-curable ink comprises a dye-based ink and a pigment-based ink.

5. The building board according to claim 1, wherein
the light stabilizer is a hindered amine-based light stabilizer, and
the ultraviolet absorbent is at least either organic- or inorganic-based.

6. The building board according to claim 1, wherein the clear coating film is at least any from among an acrylic silicone resin, a fluororesin and an inorganic material.

7. A method of producing a building board, comprising the steps of:
implementing base coating onto a surface of an inorganic board;
performing inkjet coating on the surface of the base-coated inorganic board; and
performing clear coating on the surface of the inkjet-coated inorganic board, wherein
the inkjet coating is performed by applying a UV-curable ink and curing the UV-curable ink through irradiation of UV rays; and
clear coating is performed by applying a clear coating material containing 0.1 to 10.0 wt %, on solids basis, of a light stabilizer and/or ultraviolet absorbent.

8. The method of producing a building board according to claim 7, wherein a dye-based ink is used as the UV-curable ink.

9. The method of producing a building board according to claim 7, wherein a pigment-based ink is used as the UV-curable ink.

10. The method of producing a building board according to claim 7, wherein a dye-based ink and a pigment-based ink are used as the UV-curable ink.

11. The method of producing a building board according to claim 7, wherein
the light stabilizer is a hindered amine-based light stabilizer, and
the ultraviolet absorbent is at least either organic- or inorganic-based.

12. The method of producing a building board according to claim 7, wherein at least any from among an acrylic silicone resin, a fluororesin and an inorganic material is used as the clear coating material.
